(19) United States
(12) Patent Application Publication
(10) Pub. No.: US 2022/0197117 A1
(43) Pub. Date: Jun. 23, 2022

(54) DIMMABLE PORTABLE STILL PHOTOGRAPHY BOX

(71) Applicant: SHENZHEN APEMAN INNOVATIONS TECHNOLOGY CO., LTD., SHENZHEN (CN)

(72) Inventor: YUANHUI WANG, SHENZHEN (CN)

(21) Appl. No.: 17/129,956

(22) Filed: Dec. 22, 2020

(51) Int. Cl. G03B 15/06; F21S 4/28

(52) U.S. Cl. CPC G03B 15/06; F21Y 2115/10; F21S 4/28

(57) ABSTRACT

The present disclosure provides a dimmable portable still photography box, which includes six pieces connected with each other to form a box body. The six pieces include a front piece, a left piece, a right piece, a back piece, a bottom piece, and a top piece. Each two adjacent pieces of the six pieces are connected through piece buckles or a flexible integral structure. The top piece defines a first shooting window, and an inner side of the top piece is fixedly attached with a flexible LED light strip surrounded around the first shooting window. The LED light strip is electrically connected to a dimmer outside the box body through a quick-release interface.

### FIELD OF THE PRESENT DISCLOSURE

The present disclosure relates to the field of photographic equipment, and in particular to a dimmable portable still photography box.

### DESCRIPTION OF RELATED ART

As a kind of modern high-tech product, photography boxes have appeared on the professional market in recent years and are widely used in the advertising photographic industry of precious, delicate, beautiful, and small and exquisite objects, such as jewelry, glasses, watches and mobile phones. The photography boxes are more practical, convenient, and efficient compared with ordinary cameras and even mobile phones. It only takes one minute to use the photography box to take pictures with pure colors and professional studio shooting effect.

In some technical solutions of the related art, the technical problem of the traditional photography box being large and not easy to carry can be solved by folding and unfolding the photography box. However, lamps which are used with the photography box are still inconvenient to carry. In some other technical solutions of the related art, a built-in LED is adopted for lighting the photography box, but the built-in LED cannot be folded with the box, which is inconvenient to operate.

### SUMMARY OF THE PRESENT DISCLOSURE

In view of the shortcomings in the related art, the present disclosure provides a dimmable portable still photography box, which includes an LED attached in the photography box and around the shooting window of the photography box, and a dimmer configured to adjust brightness and/or colors of the LED shooting window, so as to obtain the dimmable portable still photography box combining a light supplement lamp and the photography box together.

A dimmable portable still photography box includes six pieces connected with each other to form a box body, the six pieces include a front piece, a left piece, a right piece, a back piece, a bottom piece, and a top piece, each two adjacent pieces of the six pieces are connected through a piece buckle or a flexible integral structure, the top piece defines a first shooting window, a flexible LED light strip is fixedly attached to an inner side of the top piece and surrounded around the first shooting window, and the LED light strip is electrically connected to a dimmer outside the box body through a quick-release interface. The dimmer is configured to adjust brightness and/or colors of the LED light strip.

Preferably, a knob is arranged on the dimmer, and the knob is configured to adjust the brightness and/or to switch the color.

In order to further improve the convenience of operating the still photography box, the still photography box further includes a remote controller wirelessly connected with the dimmer, and the remote controller is configured to remotely control the dimmer.

The dimmable portable still photography box has a folded state in which the six pieces are stacked, and an unfolded state in which the six pieces are connected with each other to form the box body. In the description with regard direction, such as “top”, “bottom”, “back”, etc., refer to the top side, bottom side, and back side of the box body of the still photography box in the unfolded state; the description such as “inner side”, “outer side”, etc., refer to spatial positions of the still photography box in the unfolded state.

The still photography box is formed by six flexible pieces, some adjacent pieces are connected through the flexible integral structure to fold the pieces conveniently, and some other adjacent pieces are connected through piece buckles to form the box body and disassemble and fold the pieces conveniently. The LED light strip is flexible, and is installed on a flexible circuit and attached to an inner side of the top piece, so that the LED light strip can be conveniently stored along with the folding of time still photography box. As such, illumination and portability of the still photography box are achieved simultaneously.

Preferably, reflective films are attached to inner sides of the left piece, the right piece, the front piece, and the top piece, and the LED light strip is attached to the reflective film on the inner side of the top piece.

In order to make the light in the box body more uniform and to eliminate dark corners, reflective films are attached on the inner sides of the left piece, the right piece, the front piece, and the top piece, so as to achieve a better shooting effect. The back piece and bottom piece are often used as background surfaces, so there is no need to attach reflective films on the back piece and bottom piece. The back piece and bottom piece can be covered with colored PVC materials to obtain desired background color. Therefore, the reflective films are preferably attached on the inner sides of the left piece, the right piece, the front piece, and the top piece.

Preferably, the front piece defines a second shooting window.

It is more suitable for shooting a front view of an object from the first shooting window of the still photography box. Commonly, a light supplement lamp is arranged near the first shooting window in order to provide brighter light and to facilitate shooting other views of the object. However, it is inconvenient to arrange the light supplement lamp at the first shooting window. Therefore, the front piece of the present disclosure defines the second shooting window.

Preferably, the first shooting window and the second shooting window are provided with a first flexible shielding curtain and a second flexible shielding curtain, and the first shielding curtain and the second shielding curtain are respectively connected with the top piece and the front piece through shielding curtain buckles.

In order to reduce sundries falling into the box and an influence of external light on the imaging of the object in the box, the flexible shielding curtains are arranged to cover the first shooting window and the second shooting window. Reflective films are provided and attached on inner sides of the first shielding curtain and the second shielding curtain.

Preferably, the second shielding curtain includes an upper shielding curtain and a lower shielding curtain, and the upper shielding curtain and the lower shielding curtain are overlapped with each other.

Photographer's own imaging may affect the shooting effect, while the overlapped upper shielding curtain and lower shielding curtain can cover the second shooting window to reduce the influence of the photographer's own imaging on the shooting effect.

Preferably, the top piece, the back piece, the bottom piece, and the front piece are connected through the flexible integral structure in sequence, the left piece and right piece are connected to two sides of the back piece by the flexible integral structure, a wing is connected to the bottom piece by the flexible integral structure, and other connections are performed by the piece buckles.

In order to optimize the structure and facilitate the unfolding and folding of the still photography box, the top piece, the back piece, the bottom piece, and the front piece are connected by the flexible integral structure in sequence, and the left piece and the right piece are connected to two sides of the back piece by the flexible integral structure. The advantage of the design is that the pieces are connected with each other, which would not be lost after being folded. Further, the positions of the pieces are determined, thus avoids the troubles of finding corresponding pieces when the still photography box is in unfolded state.

Preferably, each piece buckle is arranged on a side of one of the pieces contacted with the other piece.

The piece buckles can connect the pieces together conveniently in an unfolding process of the still photography box. Thus, when the pieces are placed. in place, the still photography box can be automatically assembled. Compared with some other fixing elements, the piece buckles can greatly improve the use experience and shorten the operating time of assembling the still photography box.

The dimmer is connected with a power connector, and the power connector is configured to provide power for the LED light strip and the dimmer; a switch is also arranged between the dimmer and the power connector, and the switch is configured to turn on/off the power.

The remote controller, the dimmer, and the power connector for the LED light strip should be properly handled to improve the portability of the still photography box. Commonly, the power supply for the LED light strip is large in size, which is inconvenient to be carried. In the present disclosure, the remote controller, the dimmer, and the power connector are stored in a storage bag, users can easily carry the whole set of equipment as long as they carry the still photography box, which is much more convenient.

Preferably, the storage bag for accommodating the remote controller, the dimmer, and the power connector is arranged at an outer side of the back piece.

Preferably, the six pieces have an unfolded state in which the six pieces support each other to form the box body, and a folded state in which the six pieces are stacked in sequence; a wing for wrapping the six pieces in the folded state is connected at a joint of the bottom piece and the front piece; and a handle is arranged on an outer side of the joint of the wing and the bottom piece.

In order to carry the still photography box more conveniently, the wing fixing with the bottom piece and front piece is fixed to an outer side of the back piece in the folded state, and an outer side of a joint between the fixed wing and bottom piece becomes a top surface of the still photography box in the folded state, so it is in line with the user's operating habits to arrange the handle at the outer side of the joint.

Preferably, the LED light strip is a light strip enclosed in a rectangular structure, and surrounded around the first shooting window.

In order to achieve uniform lighting effect, the LED light strip is arranged as a closed rectangular structure and surrounded around the first shooting window. The LED light strip cooperates with a reflector to eliminate the dark corners. For facilitating the power controlling and adjusting, the LED light strip is designed to be an integration and enclosed as a rectangular structure.

The present disclosure has the following advantages:

(1) The LED light strip is arranged in the box body, which overcomes the inconveniences caused by external light supplement lamp;

(2) In the folded state, the still photography box has a size equal to that of one single piece and a thickness equal to 7 times of that of single piece, so the photography box is convenient to be carried;

(3) The pieces are connected through the piece buckles and the flexible integral structure, so that the still photography box can be easily folded or unfolded in 10 seconds; and

(4) The brightness and/or the colors can be adjusted by the dimmer.

### BRIEF DESCRIPTION OF THE DRAWINGS

FIG. 1 is a front view of a dimmable portable still photography box in an unfolded state according to an exemplary embodiment;

FIG. 2 is a back view of the dimmable portable still photography box in FIG. 1;

FIG. 3 is a perspective view of the dimmable portable still photography box in FIG. 1; and

FIG. 4 is a structure diagram of the dimmable portable still photography box in a folded state.

### BRIEF DESCRIPTION OF THE DRAWINGS

100, LED light strip; 101, front piece; 102, left piece; 103, top piece; 104, first shielding curtain; 105, upper shading curtain; 106, wing; 107, lower shading curtain; 108, back piece; 109, first shooting window; 110, right piece; 111, bottom piece; 112, handle; 113, storage bag; 120, dimmer; 121, power connector; 122, switch; 123, remote control.

### DETAILED DESCRIPTION OF THE EXEMPLARY EMBODIMENT

The present disclosure will be further described in detail below through specific embodiments in conjunction with the drawings. Among them, similar elements in different embodiments are labeled with related similar element numbers. In the following embodiments, many detailed descriptions are used to make the present disclosure to be better understood. However, those skilled in the art can easily realize that some of the features can be omitted under different circumstances, or can be replaced by other elements, materials, and methods. In some cases, some operations related to the present disclosure are not shown or described in the specification, to avoid core parts of the present disclosure being overwhelmed by too much descriptions. For those skilled in the art, it is not necessary to describe these related operations in detail. They can fully understand the related operations based on the descriptions in the specification and general technical knowledge in the field.

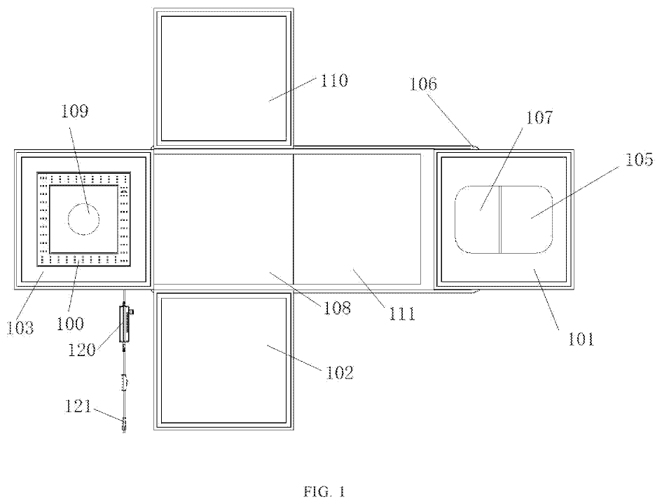

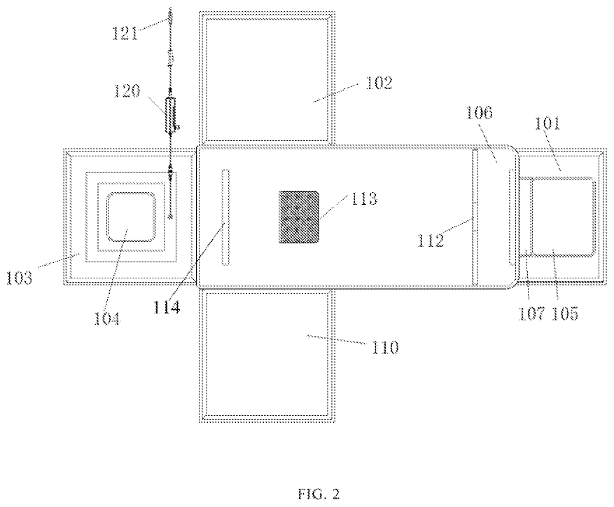

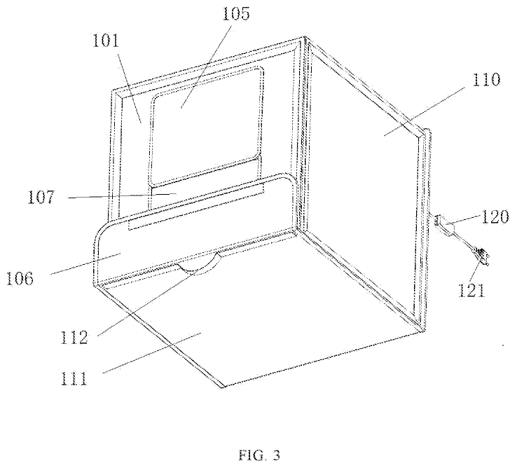

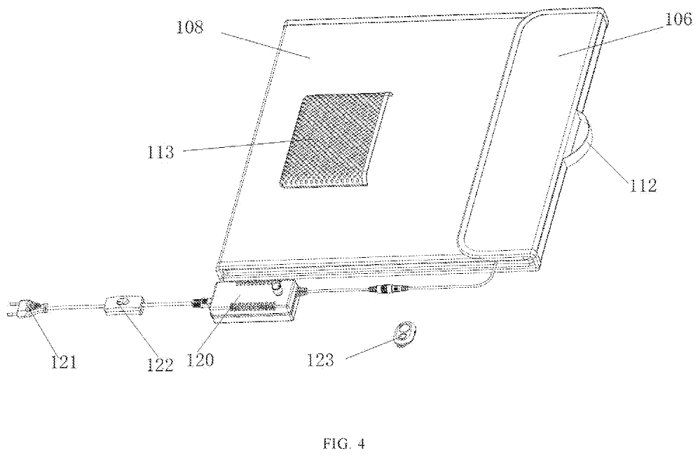

Referring to FIGS. 1 to 4, the present disclosure provides a dimmable portable still photography box, which includes six pieces connected with each other to form a box body. The six pieces includes a front piece 101, a left piece 102, a right piece 110, a back piece 108, a bottom piece 111, and a top piece 103. Each two adjacent pieces of the six pieces are connected by piece buckles or a flexible integral structure. The top piece 103 defines a first shooting window 109. The front piece 101 defines a second shooting window. An inner side of the top piece 103 is fixedly attached with a flexible LED light strip 100 surrounded around the first shooting window 109. The LED light strip 100 is electrically connected with a dimmer 120 arranged outside the box body through a quick-release interface, and the dimmer 120 is configured to adjust brightness and/or colors of the LED light strip 100.

A knob is arranged on the dimmer 12 and file knob is configured to adjust brightness and/or to switch colors.

In some embodiments, the still photography box further includes a remote controller 123 wirelessly connected with the dimmer 120, the remote controller 123 is configured to remotely control the dimmer 120 to adjust brightness and/or to switch colors of the LED light strip 100.

The LED light strip is a light strip enclosed in a rectangular structure and surrounded around the first shooting window 109. The left piece 102, the right piece 110, the front piece 101, and the top piece 103 are covered with reflective films, and the LED light strip is attached to the reflective film on the inner side of the top piece 103.

The dimmer 120 is also connected with a power connector 121, and the power connector 121 is configured to provide power for the LED light strip 100 and the dimmer 120, A switch 122 for turning on/off the power may also be arranged between the dimmer 120 and the power connector 121. A storage bag 113 for storing the remote controller 123, the dimmer 120, and the power connector 121 is also arranged at an outer side of the back piece 108.

The first shooting window 109 is covered with a flexible first shielding curtain 104, the first shielding curtain 104 is connected with the top piece 103 through a shielding curtain buckle. The second shooting window is covered with a flexible second shielding curtain, the second shielding curtain includes an upper shielding curtain 105 and a lower shielding curtain 107 which are overlapped with each other, and the second shielding curtain is connected with the front piece 101 through another shielding curtain buckle.

The top piece 103, the back piece 108, the bottom piece 111, and the front piece 101 are connected by the flexible integral structure in sequence. The left piece 102 and the right piece 110 are connected to two sides of the back piece 108 by the flexible integral structure. A wing 106 is connected to the bottom piece 111 by the flexible integral structure, and other connections are performed by the piece buckles. The piece buckle is arranged on a side of one of the pieces that is in contact with the other piece.

The six pieces have an unfolded state in which the six pieces support each other to form the box body, and a folded state in which the six pieces are stacked in sequence. The wing 106 for wrapping the six pieces in the folded state is connected at a joint of the bottom piece 111 and the front piece 101. An outer side of a connecting portion of the wing 106 and the bottom piece 111 is provided with a handle 112.

The process of folding the box body includes:

1. Closing the first and second shielding curtains, disconnecting the power supply from the LED light strip through the quick-release interface, and placing the remote controller 123, the dimmer 120, and the power connector 121 into the storage bag 113;

2. Lifting up the top piece 103 from an upper side of the front piece 101 by taking an upper lateral side of the back piece 108 as an axis, disconnecting the piece buckle connected between the top piece 103 and the front piece 101, and disconnecting the piece buckle connected between the left piece 102 and the right piece 110.

3. Lifting up the front piece 101 along a direction opposite to the back piece 108 by taking a connecting edge of the front piece 101 and the bottom piece 111 as an axis, disconnecting the connection between the front piece 101 and the left piece 102, and disconnecting the connection between the front piece 101 and the right piece 110.

4. Rotating the left piece 102 and the right piece 110 towards the back piece 108 by taking a connecting edge of the back piece 108 and the bottom piece 111 as an axis, disconnecting the piece buckle connected between the left piece 102 and the bottom piece 111, and disconnecting the piece buckle connected between the right piece 110 and the bottom piece 111;

5. Folding the left piece 102 inwards by taking a connecting edge of the left piece 102 and the back piece 108 as an axis; and folding the right piece 110 inwards by taking a connecting edge of the right piece 110 and the back piece 108 as an axis (the right piece 110 can also be folded before the left piece 102);

6. Folding the front piece 101 towards the bottom piece 111 by taking a connecting edge of the front piece 101 and the bottom piece 111 as an axis; and folding the top piece 103 towards the back piece 108 by taking a connecting edge of the top piece 103 and the back piece 108 as an axial;

7. Folding the back piece 108 which is attached with the left piece 102, the right piece 110 and the top piece 103 towards the bottom piece 111 which is attached with the front piece 101 by taking the connecting edge of the back piece 108 and the bottom piece 111 as the axis; and

8. Wrapping the folded pieces by the wing 106 on the bottom piece 111, and connecting the wing 106 with the piece buckle on the hack piece 108. As such, the folding process is finished.

Unfolding the dimmable portable still photography box just need to reverse the operation of folding the photography box.

The above specific embodiments are applied to illustrate the present disclosure, only to help understand the present disclosure, and not to limit the present disclosure. For those skilled in the technical field, several simple deductions, modifications or substitutions can also be made based on the ideas of this application.

1. A dimmable portable still photography box, comprising six pieces connected with each other to form a box body, the six pieces including a front piece, a left piece, a right piece, a back piece, a bottom piece, and a top piece, wherein each two adjacent pieces of the six pieces are connected through a flexible integral structure, the top piece defines a first shooting window, a flexible LED light strip is fixedly attached to an inner side of the top piece and surrounded around the first shooting window, and the LED light strip is electrically connected to a dimmer arranged outside the box body through a quick-release interface; and
wherein the front piece defines a second shooting window, the first shooting window and the second shooting window are respectively covered with a first flexible shielding curtain and a second flexible shielding curtain, and the first flexible shielding curtain and the second flexible shielding curtain are respectively connected with the top piece and the front piece;
wherein the dimmer is connected with a power connector, the power connector is configured to provide power for the LED light strip and the dimmer; and
wherein the six pieces have an unfolded state in which the six pieces support each other to form the box body and a folded state in which the six pieces are stacked in sequence; a wing for wrapping the six pieces in the folded state is connected at a joint of the bottom piece and the front piece, the wing in the folded state is connected with a piece buckle on the back piece to wrap the six pieces.

2. The dimmable portable still photography box of claim 1, wherein reflective films are attached to inner sides of the left piece, the right piece, the front piece, and the top piece, and the LED light strip is attached to the reflective film on the inner side of the top piece.

3-4. (canceled)

5. The dimmable portable still photography box of claim 1, wherein the second shielding curtain comprises an upper shielding curtain and a lower shielding curtain, and the upper shielding curtain and the lower shielding curtain are overlapped with each other.

6. The dimmable portable still photography box of claim 1, wherein the top piece, the back piece, the bottom piece, and the front piece are connected by the flexible integral structure in sequence, the left piece and the right piece are connected to two sides of the back piece by the flexible integral structure, and a wing is connected to the bottom piece by the flexible integral structure.

7. (canceled)

8. The dimmable portable still photography box of claim 1, wherein a storage bag for storing the dimmer and the power connector is arranged at an outer side of the back piece.

9. The dimmable portable still photography box of claim 1, wherein a handle is arranged on an outer side of the joint of the wing and the bottom piece.

10. The dimmable portable still photography box of claim 1, wherein the dimmable portable still photography box further comprises a knob arranged on the dimmer, and a remote controller wirelessly connected with the dimmer.

11. The dimmable portable still photography box of claim 2, wherein the dimmable portable still photography box further comprises a knob arranged on the dimmer, and a remote controller wirelessly connected with the dimmer.

12-13. (canceled)

14. The dimmable portable still photography box of claim 5, wherein the dimmable portable still photography box further comprises a knob arranged on the dimmer, and a remote controller wirelessly connected with the dimmer.

15. The dimmable portable still photography box of claim 6, wherein the dimmable portable still photography box further comprises a knob arranged on the dimmer, and a remote controller wirelessly connected with the dimmer.

16. (canceled)

17. The dimmable portable still photography box of claim 8, wherein the dimmable portable still photography box further comprises a knob arranged on the dimmer, and a remote controller wirelessly connected with the dimmer.

18. The dimmable portable still photography box of claim 9, wherein the dimmable portable still photography box further comprises a knob arranged on the dimmer, and a remote controller wirelessly connected with the dimmer.
